(19) United States
(12) Patent Application Publication
(10) Pub. No.: US 2023/0383685 A1
(43) Pub. Date: Nov. 30, 2023

(54) TRANSMISSION CATALYST HEATING ASSIST SYSTEM

(71) Applicants: Brian J Jacobs, Romeo, MI (US); Joshua Haviland, Waterford, MI (US); Dinesh Venkatesan, Shelby Township, MI (US); Samuel T Phelps, Royal Oak, MI (US)

(72) Inventors: Brian J Jacobs, Romeo, MI (US); Joshua Haviland, Waterford, MI (US); Dinesh Venkatesan, Shelby Township, MI (US); Samuel T Phelps, Royal Oak, MI (US)

(21) Appl. No.: 17/825,436

(22) Filed: May 26, 2022

(51) Int. Cl. F01N 9/00; F02D 41/02; F01N 3/20

(52) U.S. Cl. CPC F01N 9/00; F02D 41/0255; F01N 3/2013; F02D 2041/026

(57) ABSTRACT

A vehicle includes an engine, a torque converter, a transmission having a hydraulic system with a transmission fluid pump, an exhaust aftertreatment system having a catalytic converter with a catalyst light-off temperature, and a controller. The controller is programmed to perform at least one of the following during a cold catalyst condition: (i) a controlled transmission clutch lock up to stall the torque converter and create a fluid shearing across that torque converter to thereby increase engine load, and (ii) increase fluid line pressure in the hydraulic system to increase load on the transmission fluid pump, to thereby increase engine load, wherein the engine load increase causes the engine to be operated at a higher load to maintain an idle rpm, thereby increasing heat and mass flow to the catalytic converter to rapidly reach the catalyst light-off temperature.

### FIELD

The present application generally relates to vehicle exhaust aftertreatment systems and, more particularly, to systems for rapidly heating a catalytic converter in a vehicle.

### BACKGROUND

In conventional internal combustion aftertreatment systems, it is difficult to achieve low tailpipe emissions in the time immediately following a cold engine start due to the low catalyst conversion efficiency of cold catalysts. In order to achieve acceptable conversion efficiency, the catalyst must surpass a predetermined light-off temperature as quickly as possible. Promoting this rapid catalyst heat up generally involves increasing exhaust heat and mass flow through the catalytic converter. However, the heat and mass flow can be limited by the amount of load available to be placed on the engine, which can result in potentially longer warm up times and increased vehicle emissions. Accordingly, while such known systems do work well for their intended purpose, there exists an opportunity for improvement in the relevant art.

### SUMMARY

According to one example aspect of the invention, a vehicle is provided. In one exemplary implementation, the vehicle includes an engine, a torque converter, a transmission having a hydraulic system with a transmission fluid pump, an exhaust aftertreatment system having a catalytic converter with a catalyst light-off temperature, and a controller. The controller is programmed to perform at least one of the following during a cold catalyst condition: (i) a controlled clutch lock up to stall the torque converter and create a fluid shearing across that torque converter to thereby increase engine load, and (ii) increase fluid line pressure in the hydraulic system to increase load on the transmission fluid pump, to thereby increase engine load, wherein the engine load increase causes the engine to be operated at a higher load to maintain an idle rpm, thereby increasing heat and mass flow to the catalytic converter to rapidly reach the catalyst light-off temperature.

In addition to the foregoing, the described vehicle may include one or more of the following features: wherein the controller is programmed to perform each of (i) the controlled clutch lock up and (ii) the increase in fluid line pressure during the cold catalyst condition; wherein the transmission fluid pump is configured to supply hydraulic fluid through a hydraulic line; wherein the controller is programmed to create a restriction in the hydraulic line to perform the (ii) increase in fluid line pressure in the hydraulic system; and wherein creating the restriction includes at least partially closing a valve disposed on the hydraulic line.

According to another example aspect of the invention, a method of operating a vehicle to rapidly reach a catalyst light-off temperature during a cold catalyst condition, the vehicle including an engine, a torque converter, a transmission with a hydraulic system and transmission fluid pump, and an exhaust aftertreatment system having a catalytic converter is provided. In one example implementation, the method includes determining if a temperature of the catalytic converter is below the predefined catalyst light-off temperature, and performing, with a controller, at least one of (i) a controlled clutch lock up to stall the torque converter and create a fluid shearing across that torque converter to thereby increase engine load, and (ii) increase fluid line pressure in the hydraulic system to increase load on the transmission fluid pump, to thereby increase engine load, wherein the engine load increase causes the engine to be operated at a higher load to maintain an idle rpm, thereby increasing heat and mass flow to the catalytic converter to rapidly reach the catalyst light-off temperature.

In addition to the foregoing, the described vehicle may include one or more of the following features: performing each of (i) the controlled clutch lock up and (ii) the increase in fluid line pressure; operating the transmission fluid pump to supply hydraulic fluid through a hydraulic line; wherein the performing the (ii) increase in fluid line pressure in the hydraulic system comprises creating a restriction in the hydraulic line; and wherein creating the restriction in the hydraulic line comprises at least partially closing a valve disposed on the hydraulic line.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic illustration of an example vehicle powertrain system, in accordance with the principles of the present application;

FIG. 2 is a flow diagram of an example method of controlling a vehicle for rapidly achieving catalyst light-off temperature, in accordance with the principles of the present application; and

FIG. 3 is a multi-graphical illustration of example vehicle performance data when performing the method shown in FIG. 2 and compared to baseline performance data, in accordance with the principles of the present application.

### DESCRIPTION

Described herein are systems and methods for rapidly heating vehicle catalytic converters after a cold start. The systems are configured to greatly increase the loading potential to be placed on the engine, thereby increasing mass flow and temperature, which reduces catalyst warmup time and emissions. In particular, upon startup, the vehicle is configured to (i) increase transmission fluid pressure request from the transmission fluid pump and/or (ii) command the transmission into a locked-up state while in park idle to stall the torque converter. Such operations are configured to increase engine load to rapidly heat the catalyst.

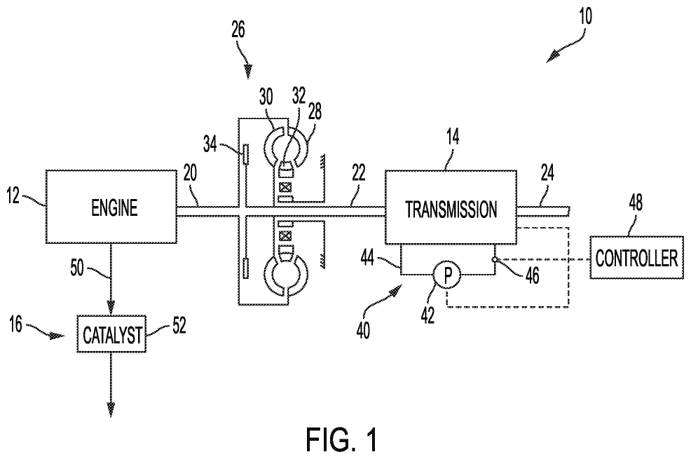

Referring now to FIG. 1, a schematic illustration of an example vehicle 10 is shown that generally includes an internal combustion engine 12, an automatic transmission 14, and an exhaust aftertreatment system 16. As described herein in more detail, during a cold start or other low temperature condition, the automatic transmission 14 is controlled in such a way that engine load is increased to thereby increase heat and mass flow to the exhaust aftertreatment system 16. As illustrated in FIG. 1, engine 12 includes an output shaft 20, and automatic transmission 14 includes an input shaft 22 and an output shaft 24. Positioned between engine output shaft 20 and transmission input shaft 22 is a torque converter 26.

In the illustrated example, the torque converter 26 includes an impeller 28 operatively connected to engine output shaft 20, a turbine 30 operatively connected to transmission input shaft 22, and a stator 32 disposed between impeller 28 and turbine 30. A lockup clutch 34 is selectively engaged to mechanically connect impeller 28 for rotation with the turbine 30. The lockup clutch 34 may be completely engaged, whereby impeller 28 rotates together with turbine 30 without substantial slip, or may be partially engaged, whereby impeller 28 rotates together with turbine 30 with some degree of slip. It will be appreciated that torque converter 26 is not limited to the described configuration and may have various other configurations.

In the example embodiment, the transmission 14 includes a hydraulic system 40 configured to operate one or more pumps 42 to implement fluidic pressures in one or more hydraulic lines 44 to selectively actuate clutches or other components (not shown) within the transmission 14. The pump 42 is configured to pressurize the hydraulic fluid (e.g., oil) and supply the pressurized fluid to the desired area. A pressure control device or valve 46 (e.g., orifice, solenoid, etc.) is disposed on the hydraulic line 44 and configured to selectively restrict hydraulic line 44 and control a flow of hydraulic fluid through the hydraulic system 40. It will be appreciated that hydraulic system 40 is merely illustrated in FIG. 1 with one hydraulic line 44, one pump 42 and one valve 46 for simplicity, but that system 40 may have any suitable number of lines, pumps, and valves.

In the example implementation, a controller 48 (e.g., a transmission control module), is in signal communication with the hydraulic system 40 including the pump(s) 42 and valve(s) 46 to monitor inputs from pressure sensors/switches (not shown) and selectively actuate pump(s) 42 and valve(s) 46 to operate in various transmission modes. As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

In the example embodiment, the exhaust aftertreatment system 16 is fluidly coupled to the internal combustion engine 12 and is configured to receive exhaust gas therefrom. During operation, intake air is combusted in the engine 12, and the resulting exhaust gas is then directed to a main exhaust conduit 50, which includes one or more catalytic converters 52 to reduce or convert a particular exhaust gas constituent such as, for example, carbon monoxide (CO), hydrocarbons (HC), and/or nitrogen oxides (NOx). In one example, the catalytic converter 52 is a three-way catalyst configured to remove CO, HC, and NOx from the exhaust gas passing therethrough. However, it will be appreciated that catalysts 52 may be any suitable catalyst that enables exhaust aftertreatment system 16 to remove any desired pollutant or compound such as, for example, a hydrocarbon trap or a four-way catalyst.

In order to efficiently reduce or convert CO, HC, and NOx, the catalytic converters 52 must reach a predetermined light-off temperature. However, during some vehicle operations such as, for example, cold starts, long idle, and cold catalyst conditions, the catalytic converters 52 are below light-off temperature and therefore have a low catalyst conversion efficiency. In order to advantageously achieve quicker catalyst light-off times than conventional systems, the described system is configured to selectively create a lockup condition in the transmission via software and calibration by commanding a controlled clutch lock up. Example transmissions and lockup strategies include those described in commonly owned U.S. patent application Ser. No. 15/409,909, filed Jan. 19, 2017, the entire contents of which are incorporated herein by reference thereto. As a result of the controlled clutch lockup, the competing clutch elements bring the input shaft 22 of the geartrain to zero rpm, which brings the torque converter turbine 30 to zero rpm.

However, since the engine 12 is still driving the torque converter impeller 28 at engine idle rpm, the result is fluid shearing across the torque converter 26. This increases the engine loading as the engine 12 must work harder to overcome the fluid shearing to maintain idle rpm. As such, engine loading becomes the equivalent of RPM squared divided by the torque converter K factor (at stall) squared:

$${Moment}_{flywheel} = \frac{{RPM}_{motor}^{2}}{{K}_{factor}^{2}}$$

In addition to the controlled clutch lock up, the described system can also achieve quicker catalyst light-off times by increasing the transmission fluid line pressure request with pressure control valve 46. By restricting hydraulic line 44 via valve 46, mechanical or electrical loading on pump 42 is increased as the pump tries to maintain the commanded rpm for the desired flow. This results in increased load either directly (for a pump driven by the engine), or indirectly (through battery drain and increased alternator loading for an electrically driven pump). Both the clutch lockup and increased transmission fluid line pressure strategies may be utilized together or independently in any desired order or timing depending on the type of system and desired catalyst light-off time.

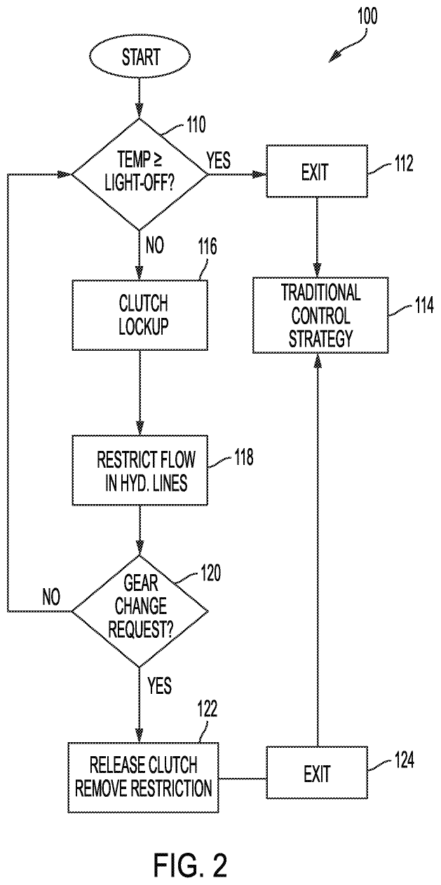

FIG. 2 illustrates an example method 100 of operating vehicle 10 in an example light-off assist mode in a low temperature condition such as, for example, a cold engine start. At step 110, controller 48 determines if a temperature of catalyst 52 greater than a predetermined threshold (e.g., catalyst light-off temperature). If yes, at step 112, control exits the light-off assist mode and proceeds to a traditional control strategy at step 114. If no, at step 116, controller 48 initiates a clutch lock up operation in the transmission 14 to establish the torque converter stall. This causes the engine 12 to be operated at a higher load to maintain idle rpm against the fluid shearing in the stalled torque converter 26, thereby increasing heat and mass flow to the catalyst 52.

In the example embodiment, control then proceeds to step 118 where controller 48 commands the valve(s) 46 to restrict flow within fluid line(s) 44 to thereby increase the load on pump(s) 42 as they attempt to maintain pump rpm for vehicle idle conditions. This causes an indirect or direct increase of the load on engine 12, which causes the engine to be operated at a higher load to further maintain idle rpm against the increased pump load, and further increases. As a result of the increased engine load, exhaust gas with increased heat and mass flow is directed to the catalyst 52 for quicker light-off. In some implementations, only one of steps 116 and 118 are performed, for example, when the temperature of the catalyst is above a second predetermined threshold that is close to the previously mentioned predetermined threshold.

At step 120, controller 48 determines if a gear state change request has occurred to move the transmission from Park to Neutral, Reverse, or Drive. If no, control returns to step 110. If yes, at step 122, controller 48 releases the clutch lockup (if locked) and removes the restriction within fluid lines 44 if restricted (e.g., opens valves 46 to normal opening). At step 124, control exits the light-off assist mode and proceeds to the traditional control strategy at step 114.

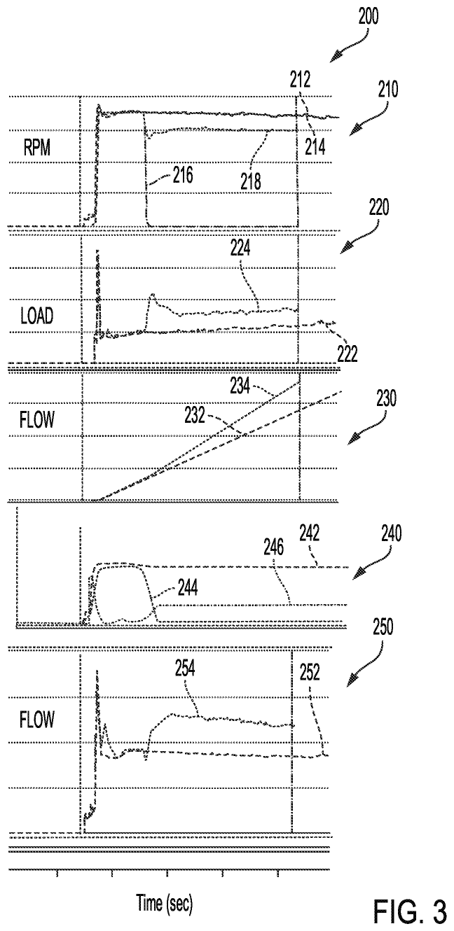

FIG. 3 provides a series of graphs 200 illustrating various vehicle conditions during one example operation from a cold start into the catalyst light-off assist mode. Graph 210 illustrates turbine speed in the torque converter 26. Lines 212 and 214 respectively illustrate conventional engine RPM and turbine speed, which are relatively close to each other due to low load neutral state. However, in light-off assist mode, line 216 illustrates turbine speed to zero and line 218 illustrates lowered engine RPM, which creates a high RPM delta across the torque converter 26. In the example embodiment, graph 220 illustrates torque converter shearing. Line 222 illustrates conventional torque converter shearing, and line 224 illustrates torque converter shearing during the light-off assist mode. The increased torque converter shearing in line 224 is configured to increase engine load.

Graph 230 illustrates intake manifold airflow. Line 232 illustrates conventional mass airflow, and line 234 illustrates increased intake manifold airflow with the higher engine load of the light-off assist mode. Graph 240 illustrates effects of the catalyst light-off mode. Line 242 illustrates engine RPM at cold idle set point. Line 244 illustrates torque converter stall from the multiple transmission clutch element lockup, which causes fluid shearing and increased loading. Line 246 illustrates how engine load is increased to maintain idle while overcoming the additional load of the clutch lockup (and in some cases the increased fluid line pressure). Graph 250 illustrates exhaust gas flow through the catalyst 52. Line 252 illustrates exhaust gas flow through the catalyst 52 during a conventional start. Line 254 illustrates increased exhaust gas flow through the catalyst 52 due to the operation in the catalyst light-off assist mode.

Described herein are systems and methods to promote rapid catalyst heating while a vehicle is idling on a cold start. In a catalyst light-off assist mode, the transmission is commanded into a locked-up state while in park idle to stall the torque converter and increase engine load. Additionally, increasing fluid pressure in the transmission causes the transmission fluid pump to increase load on the engine. The increased engine load causes the engine to increase rpm to maintain idle rpm, thereby increasing heat and mass flow to the catalyst for quicker light-off.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A vehicle having a catalyst heating assist system, comprising:
an engine;
a torque converter;
a transmission operably coupled to the engine via the torque converter, the transmission having a hydraulic system with a transmission fluid pump;
an exhaust aftertreatment system having a catalytic converter with a catalyst having a catalyst light-off temperature; and
a controller programmed to perform each of the following during a cold catalyst condition:
(i) a controlled transmission clutch lock up to stall the torque converter and create a fluid shearing across that the torque converter to thereby increase engine load; and
(ii) increase fluid line pressure in the transmission hydraulic system to increase load on the transmission fluid pump, to thereby increase engine load, wherein the engine load increase causes the engine to be operated at a higher load to maintain an idle rpm, thereby increasing heat and mass flow to the catalytic converter to increase a temperature of the catalyst and reduce a time period to reach the catalyst light-off temperature.

2. (canceled)

3. The vehicle of claim 1, wherein the transmission fluid pump is configured to supply hydraulic fluid through a hydraulic line;
wherein during the controlled transmission clutch lock up and increased fluid line pressure, the engine is operated at a lowered engine RPM below a park idle engine RPM; and
wherein upon determining a transmission gear state change out of Park, the controller is further programmed to:
release the controlled transmission clutch lock up; and
terminate the increased fluid line pressure.

4. The vehicle of claim 3, wherein the controller is programmed to create a restriction in the hydraulic line to perform the (ii) increase in fluid line pressure in the hydraulic system.

5. The vehicle of claim 4, wherein creating the restriction includes at least partially closing a valve disposed on the hydraulic line.

6. A method of operating a vehicle to rapidly reach a catalyst light-off temperature during a cold catalyst condition, the vehicle including an engine, a torque converter, a transmission operably coupled to the engine via the torque converter and with a hydraulic system and transmission fluid pump, and an exhaust aftertreatment system having a catalytic converter with a catalyst, the method comprising:
determining if a temperature of the catalytic converter is below the predefined catalyst light-off temperature; and
performing, with a controller, each of (i) a controlled transmission clutch lock up to stall the torque converter and create a fluid shearing across that torque converter to thereby increase engine load, and (ii) an increase in fluid line pressure in the transmission hydraulic system to increase load on the transmission fluid pump, to thereby increase engine load,
wherein the engine load increase causes the engine to be operated at a higher load to maintain an idle rpm, thereby increasing heat and mass flow to the catalytic converter to increase a temperature of the catalyst and reduce a time period to reach the catalyst light-off temperature.

7. (canceled)

8. The method of claim 6, further comprising:
operating the transmission fluid pump to supply hydraulic fluid through a hydraulic line;
operating the engine at a lowered engine RPM below a park idle engine RPM during the controlled transmission clutch lock up and increased fluid line pressure;
determining a transmission gear state change out of Park, and upon the determined transmission gear state change out of Park, releasing the controlled transmission clutch lock up, and terminating the increased fluid line pressure.

9. The method of claim 8, wherein the performing the (ii) increase in fluid line pressure in the hydraulic system comprises creating a restriction in the hydraulic line.

10. The method of claim 9, wherein creating the restriction in the hydraulic line comprises at least partially closing a valve disposed on the hydraulic line.
